(19) United States
(12) Patent Application Publication
(10) Pub. No.: US 2017/0089517 A1
(43) Pub. Date: Mar. 30, 2017

(54) SYSTEM FOR NITROGEN GAS RECOVERY FROM GAS VENTS

(71) Applicant: Air Liquide Industrial U.S. LP, Houston, TX (US)

(72) Inventor: Rozalia PAPP, Orland Park, IL (US)

(21) Appl. No.: 15/170,638

(22) Filed: Jun. 1, 2016

Related U.S. Application Data
(60) Provisional application No. 62/232,665, filed on Sep. 25, 2015.

(51) Int. Cl. F17C 7/02

(52) U.S. Cl. CPC F17C 7/02

(57) ABSTRACT

A vapor recovery system is provided. One embodiment of the vapor recovery system includes a pipe which includes a gas vent, wherein a combined gas phase and liquid phase fluid flows through the pipe, and wherein the gas vent is configured to remove at least a portion of the gas phase fluid. There is a compressor downstream of the gas vent, wherein the compressor is configured to compress the removed portion of gas phase fluid, thereby forming compressed gas stream. And there is a storage tank downstream of the compressor, wherein the storage tank is configured to accumulate the compressed gas stream.

### BACKGROUND

When a cryogenic liquid flows through pipes in an industrial complex, it is common for some of the liquid to vaporize, causing a, typically undesirable, two-phase flow. This flashing may occur due to heat transfer through the pipe, or simply due to the inevitable pressure drop as the liquid travels through the piping system. It is a common practice for there to be periodic vapor removal devices, referred to as cryovents, keep-full, keep-cold, gas vents, or vapor vents. In this document, these devices will be referred to as vapor vents.

These vapor vents are mechanical venting mechanisms that have a mechanical float that allows gas to exit when the liquid level drops. If these vapor vents are properly located, and properly functioning, they will maintain a liquid fluid flow through the pipeline.

Typically, the vapor that is released from these vapor vents is simply vented to the atmosphere. In some cases, it is desirable to capture and possibly recirculate this vapor. A need exists in the industry for a means of capturing, storing, and possibly reusing the vent vapor from a vapor vent.

### SUMMARY

A vapor recovery system is provided. One embodiment of the vapor recovery system includes a pipe which includes a gas vent, wherein a combined gas phase and liquid phase fluid flows through the pipe, and wherein the gas vent is configured to remove at least a portion of the gas phase fluid. There is a compressor downstream of the gas vent, wherein the compressor is configured to compress the removed portion of gas phase fluid, thereby forming compressed gas stream. And there is a storage tank downstream of the compressor, wherein the storage tank is configured to accumulate the compressed gas stream.

### BRIEF DESCRIPTION OF THE FIGURES

FIG. 1 is a schematic representation in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure

The gas vent, also known as cryovents, keep-full, keep-cold, or vapor vents are well known to one of ordinary skill in the art. These gas vents, are typically designed with a small reservoir that is connected to the fluid handling pipeline. The gas vent may be situated at high points along the pipeline, or anywhere that the skilled artisan would know is an appropriate location. If only liquid is present in the pipeline at that location, the reservoir will thus contain only liquid. The gas vent will typically have a mechanical float that operates a vent valve. As vapor becomes present in the pipeline at this location, if properly designed and installed, this vapor will accumulate in the reservoir. This will cause the mechanical float to move and this will eventually open the vent valve, thereby allowing the vapor to leave the pipeline system.

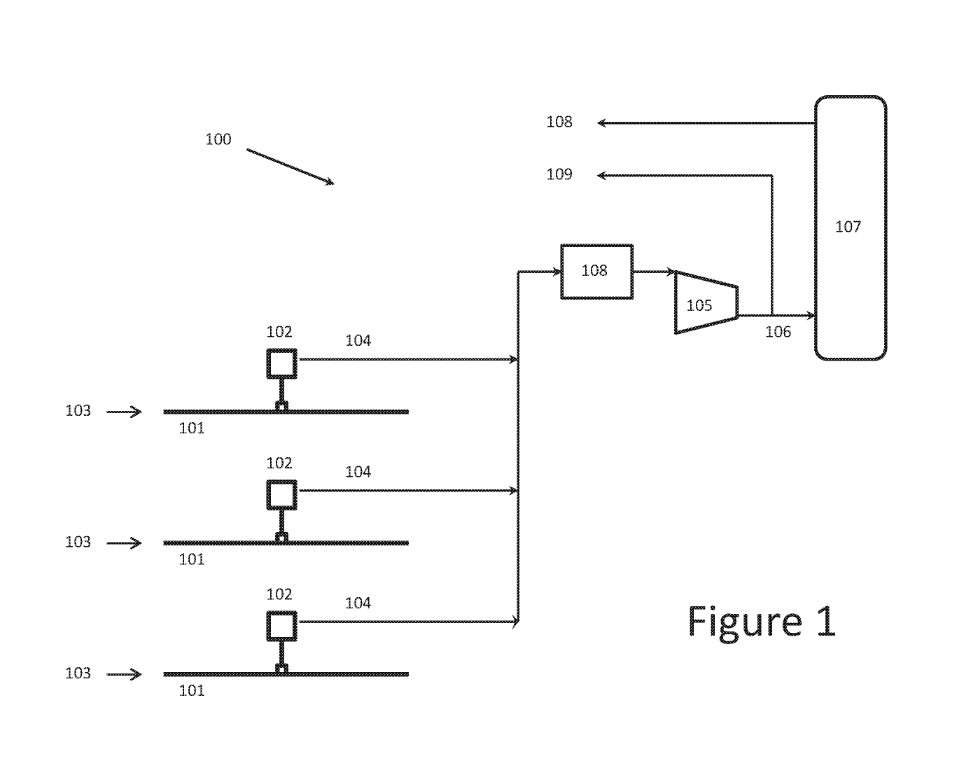

Referring to FIG. 1, the sole figure in this application, a vapor recovery system 100 is described. One embodiment of the vapor recovery system 100 includes a pipe 101 which includes a gas vent 102, wherein a combined gas phase and liquid phase fluid 103 flows through the pipe, and wherein the gas vent 102 is configured to remove at least a portion of the gas phase fluid 104. There is a compressor 105 downstream of the gas vent 102, wherein the compressor 105 is configured to compress the removed portion of gas phase fluid 104, thereby forming compressed gas stream 106. And there is a storage tank 107 downstream of the compressor 105, wherein the storage tank 107 is configured to accumulate the compressed gas stream 106.

The combined gas phase and liquid phase fluid 103 may be a cryogenic fluid. The combined gas phase and liquid phase fluid 103 may be selected from the group consisting of nitrogen, argon, oxygen, carbon dioxide, and combinations thereof. The combined gas phase and liquid phase fluid 103 may be at a pressure 5 psig or less. The compressor 105 may be configured to compress the removed portion of the gas phase fluid to at 500 psig.

In another embodiment, the vapor recovery system 100 includes a vaporizer 108 downstream of the gas vent 102 and upstream of the compressor 105, wherein the vaporizer 108 is configured to vaporize any liquid phase fluid that is entrained in compressed gas stream 106. The vaporizer 108 may heat the compressed gas stream 106 to ambient temperature. The compressor 105 is configured to compress the removed portion of the gas phase fluid to a maximum of 50 psig. The compressor 105 may be configured to compress the removed portion of the gas phase from between 25 psig and 45 psig.

In another embodiment, the vapor recovery system 100 includes an on-site user 109 downstream of the compressor 105, wherein at least a portion of the compressed gas stream 109 is utilized downstream.

In another embodiment, the vapor recovery system 100 includes an on-site user 108 downstream of the storage tank 107, wherein at least a portion of the stored compressed gas is utilized downstream.

1. A vapor recovery system (100), comprising;
a pipe (101) comprising a gas vent (102), wherein a combined gas phase and liquid phase fluid (103) flows through the pipe, and wherein the gas vent (102) is configured to remove at least a portion of the gas phase fluid (104),
a compressor (105) downstream of the gas vent (102), wherein the compressor (105) is configured to compress the removed portion of gas phase fluid (104), thereby forming compressed gas stream (106);
a storage tank (107) downstream of the compressor (105, wherein the storage tank (107) is configured to accumulate the compressed gas stream (106).

2. The vapor recovery system of claim 1, wherein the combined gas phase and liquid phase fluid (103) is a cryogenic fluid.

3. The vapor recovery system of claim 1, wherein the combined gas phase and liquid phase fluid (103) is selected from the group consisting of nitrogen, argon, oxygen, carbon dioxide, and combinations thereof.

4. The vapor recovery system of claim 1, further comprising a vaporizer (108) downstream of the gas vent (102) and upstream of the compressor (105), wherein the vaporizer (108) is configured to vaporize any liquid phase fluid that is entrained in compressed gas stream (106).

5. The vapor recovery system of claim 4, wherein the vaporizer (108) heats the compressed gas stream (106) to ambient temperature.

6. The vapor recovery system of claim 1, wherein the combined gas phase and liquid phase fluid (103) is at a pressure 5 psig or less.

7. The vapor recovery system of claim 1, wherein the compressor (106) is configured to compress the removed portion of the gas phase fluid to a maximum of 50 psig.

8. The vapor recovery system of claim 1, wherein the compressor (106) is configured to compress the removed portion of the gas phase fluid between 25 psig and 45 psig.

9. The vapor recovery system of claim 1, further comprising an on-site user (109) downstream of the compressor (105), wherein at least a portion of the compressed gas stream (109) is utilized downstream.

10. The vapor recovery system of claim 1, further comprising an on-site user (108) downstream of the storage tank (107), wherein at least a portion of the stored compressed gas is utilized downstream.
